(19) United States
(12) Patent Application Publication
(10) Pub. No.: US 2025/0373929 A1
(43) Pub. Date: Dec. 4, 2025

(54) METHOD FOR PROVIDING USER INTERFACE (UI) THAT CONTROLS SHOOTING DIRECTION OF MULTI-AXIS ROTATABLE CAMERA

(71) Applicant: Hanwha Vision Co., Ltd., Seongnam-si (KR)

(72) Inventors: Daesung KIM, Seongnam-si (KR); Jongin Park, Seongnam-si (KR); Juhee Kim, Seongnam-si (KR); Yeonwoo Kim, Seongnam-si (KR)

(73) Assignee: Hanwha Vision Co., Ltd., Seongnam-si (KR)

(21) Appl. No.: 19/297,182

(22) Filed: Aug. 12, 2025

Related U.S. Application Data
(63) Continuation of application No. PCT/KR2023/010516, filed on Jul. 20, 2023.

(30) Foreign Application Priority Data
Feb. 15, 2023 (KR) 10-2023-0019897

(51) Int. Cl. H04N 23/62; H04N 23/58; H04N 23/69; H04N 23/695

(52) U.S. Cl. CPC H04N 23/62; H04N 23/58; H04N 23/69; H04N 23/695

(57) ABSTRACT

The disclosure provides a method of providing a UI that controls a shooting direction of a multi-axis rotatable camera. According to the method, an outer circle corresponding to a pan angle of the shooting direction of the camera is provided based on a hemispherical coordinate system, and a shooting point is defined as a coordinate value on the hemispherical coordinate system using a tilt angle and a pan angle of a direction from a center point of the outer circle to the outer circle. Thus, it is possible to provide a user interface capable of intuitively controlling the shooting direction of the multi-axis rotatable camera.

### CROSS-REFERENCE TO RELATED APPLICATION(S)

This application is a continuation of International Application No. PCT/KR2023/010516, filed on Jul. 20, 2023, in the Korean Intellectual Property Receiving Office, which is based on and claims priority to Korean Patent Application No. 10-2023-0019897, filed on Feb. 15, 2023, in the Korean Intellectual Property Office, the disclosures of which are incorporated by reference herein in their entireties.

### BACKGROUND

### 1. Field

The disclosure relates to a user interface (UI) of a multi-axis rotatable camera including a pan-tilt-zoom (PTZ) camera.

### 2. Description of Related Art

With the advancement of surveillance and security systems, closed-circuit cameras which are core components of the surveillance and security systems have become core components in combination with Internet Protocol (IP). Further, with the trend toward unmanned intelligence, cameras that are able to rotate around one or more axes so that a shooting direction can be adjusted at a time according to a movement of a shooting target from a conventional fixed CCTV have appeared to reduce blind spots of the CCTV. A representative example of such a multi-axis rotatable camera is a pan-tilt-zoom (PTZ) camera.

The PTZ camera may be an integrated camera that is able to electrically adjust a horizontal rotation (PAN), vertical tilt, and zoom using a fixed motor. Although the PTZ camera is relatively expensive compared to a general fixed CCTV camera, demand for the PTZ camera may continue to grow due to several advantages.

FIG. 1 illustrates a shape of a typical PTZ camera with reference to an X-Y plane and a Z-axis in a direction orthogonal to the X-Y plane. Referring to FIG. 2, a pan rotation of the PTZ camera of FIG. 1 as viewed from the Z-axis with reference to the X-Y plane and a tilt rotation operation of the PTZ camera of FIG. 1 as viewed from the Y-axis with reference to a Z-X plane are illustrated. Thus, the PTZ camera may rotate around two or more axes to reduce blind spots of the CCTV, and a user may directly input a pan/tilt angle of the camera through various types of user interfaces or use a GUI on a display and various input tools to control the shooting direction of the camera.

### SUMMARY

As described above, a conventional user interface does not greatly differ from a shape used in an existing fixed CCTV despite the widespread use of a multi-axis rotatable camera including a PTZ camera. For example, as illustrated in FIG. 3, in the case of the PTZ camera, a graphical interface that controls an operation of the PTZ camera according to a square that is a currently widely used shape of a display screen, or an interface implemented in a form in which numerical values are directly input may be still being used.

The disclosure is intended to provide a user interface (UI) that uses a semispherical coordinate system including a pair of, for example, a pan (or yaw) angle and a tilt angle for a hemispherical shooting direction, based on the fact that the shooting direction of a multi-axis rotatable camera including a PTZ camera can be defined in a semispherical shape, thereby resolving a mismatch between the shooting direction of the PTZ camera and an existing coordinate system of a display.

The problems to be solved by the disclosure are not limited to the problem described above, and other problems that are not described may be clearly understood by those skilled in the art from the following description.

The disclosure provides a method of providing a user interface (UI) that controls a shooting direction of a multi-axis rotatable camera. The method includes providing an outer circle corresponding to a pan angle of the shooting direction of the camera, a first point on the outer circle being set as a reference point having a value of 0°; and providing a coordinate value on a hemispherical coordinate system for a second point in the outer circle, wherein the coordinate value of the point is expressed as a pair of coordinate values (a, b), where ‘a’ denotes a pan angle corresponding to a point at which a straight line extending through the point from a center point of the outer circle is tangent to the outer circle, and ‘b’ denotes a tilt angle of the camera proportional to a distance from the center point to the outer circle on the straight line based on a value of the center point on the straight line being 0° and the point tangent to the outer circle being set to correspond to a maximum tilt angle of the camera.

The method and other embodiments may include the following features:

In an aspect of the disclosure, the UI may control the pan angle and the tilt angle of the camera to correspond to the coordinate values (a, b) of the second point on the hemispherical coordinate system.

In another aspect of the disclosure, the shooting direction of the camera may be returned to a direction corresponding to a predefined default coordinate value based on a home value being input.

In yet another aspect of the disclosure, the pair of coordinate values (a, b) corresponding to the second point may be displayed on the UI.

In yet another aspect of the disclosure, one or more points may be preset on the UI so that the shooting direction of the camera is controlled.

In yet another aspect of the disclosure, two or more points may be preset on the UI and the shooting direction of the camera may be controlled to sequentially correspond to the two or more preset points.

According to the embodiments disclosed in the disclosure, it is possible to provide a user interface that is able to intuitively control a shooting direction of a multi-axis rotatable camera including a PTZ camera.

Further, according to the embodiments disclosed in the disclosure, it is possible to immediately control the camera toward a point as needed because one or more points having respective pan and tilt angle values are set in advance.

Further, according to the embodiments disclosed in the disclosure, it is possible to set a patrol function so that the camera sequentially follows two or more preset points in a group to perform shooting.

Meanwhile, the effects that can be obtained from the disclosure are not limited to the effects described above, and other effects that are not described will be clearly understood by those skilled in the art to which the disclosure belongs from the following description.

### BRIEF DESCRIPTION OF DRAWINGS

The following drawings attached to the disclosure illustrate embodiments of the disclosure and serve to further understand the technical spirit of the disclosure together with specific content for implementing the invention, and therefore, the disclosure should not be construed as being limited to matters shown in such drawings.

FIG. 1 is a perspective view illustrating a shape of a typical PTZ camera with reference to an X-Y plane and a Z-axis in a direction orthogonal to the X-Y plane.

FIG. 2 is a plan view and a side view illustrating an operation axis of the PTZ camera as viewed from the Z-axis and a Y-axis of FIG. 1.

FIG. 3 illustrates an example of a graphical user interface of a PTZ camera in the related art.

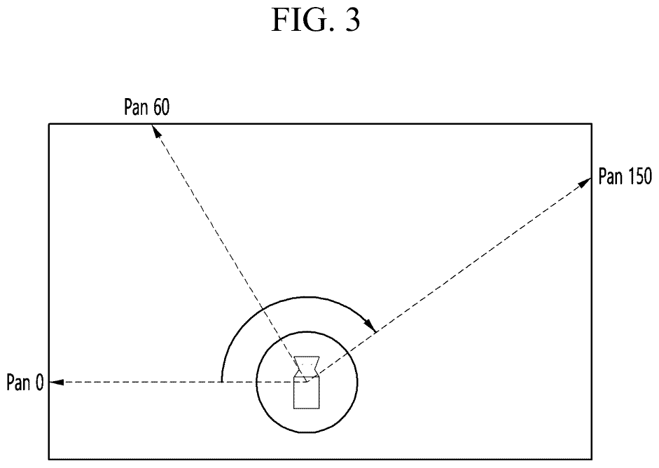

FIG. 4 illustrates a user interface of a multi-axis rotation camera based on a hemispherical coordinate system according to an embodiment of the disclosure.

FIG. 5 illustrates an example of a screen in which coordinate values of a point illustrated in FIG. 4 are displayed together with an actual captured image of the camera corresponding to the coordinate values.

FIG. 6 illustrates an embodiment of the user interface in which points are preset on the user interface of FIG. 4.

FIG. 7 illustrates a swing operation according to an embodiment in which the camera is controlled to reciprocate between the preset points.

FIG. 8 illustrates an embodiment in which a plurality of preset points are grouped on the user interface of FIG. 4.

FIG. 9 illustrates a user interface for setting a rotation operation range limit of the multi-axis rotation camera on the user interface of FIG. 4.

### DETAILED DESCRIPTION

The technology disclosed in the disclosure may be applied to a method of controlling a shooting direction of a multi-axis rotatable camera including a PTZ camera. However, the technology disclosed in the disclosure is not limited thereto, and may be applied to all devices and methods to which the technical spirit of the technology may be applied. Further, throughout the disclosure, a picture or an image is a concept that encompasses both a still image and a moving image, and a moving image is not excluded even when the picture or the image is expressed.

It should be noted that technical terms used in the disclosure are used only to describe specific embodiments and are not intended to limit the spirit of the technology disclosed in the disclosure. Further, the technical terms used in the disclosure should be construed as having meanings generally understood by those skilled in the art to which the technology disclosed in the disclosure belongs, unless specifically defined otherwise in the disclosure, and should not be construed in an excessively comprehensive or excessively narrow sense. Further, when the technical terms used in the disclosure are incorrect technical terms that do not accurately express the spirit of the technology disclosed in the disclosure, the technical terms should be replaced with technical terms that can be correctly understood by those skilled in the art to which the technology disclosed in the disclosure belongs. Further, general terms used in the disclosure should be construed according to their definitions in the dictionary or according to the context, and should not be construed in an excessively narrow sense.

Terms including ordinal numbers such as first and second used in the disclosure may be used to describe various components, but the components should not be limited by the terms. The terms are used only for the purpose of distinguishing one component from another. For example, a first component may be referred to as a second component, and similarly, a second component may also be referred to as a first component without departing from the scope of the disclosure.

Hereinafter, embodiments disclosed in the disclosure will be described in detail with reference to the accompanying drawings, and the same or similar components will be denoted by the same reference numbers regardless of the drawings and redundant description thereof will be omitted.

Further, when it is determined that specific description of related known technology may obscure the gist of the technology disclosed in the disclosure in describing the technology disclosed in the disclosure, the detailed description will be omitted. Further, it should be noted that the accompanying drawings are only intended for the purpose of facilitating the understanding of the spirit of the technology disclosed in the disclosure, and the spirit of the technology should not be construed as being limited by the accompanying drawings.

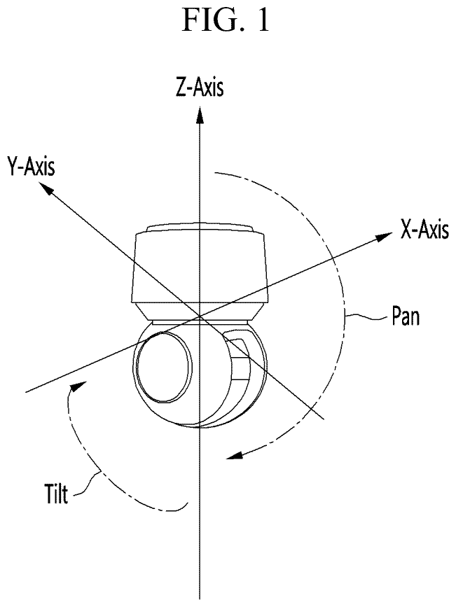

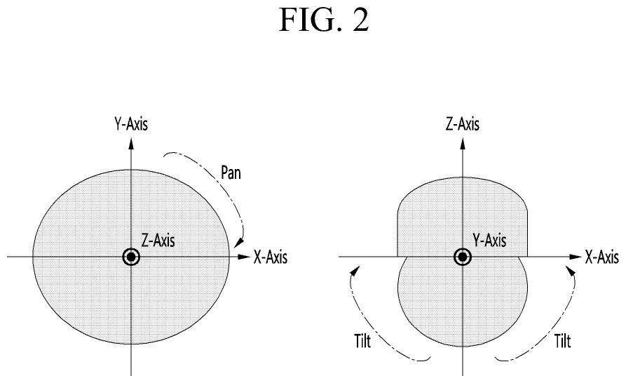

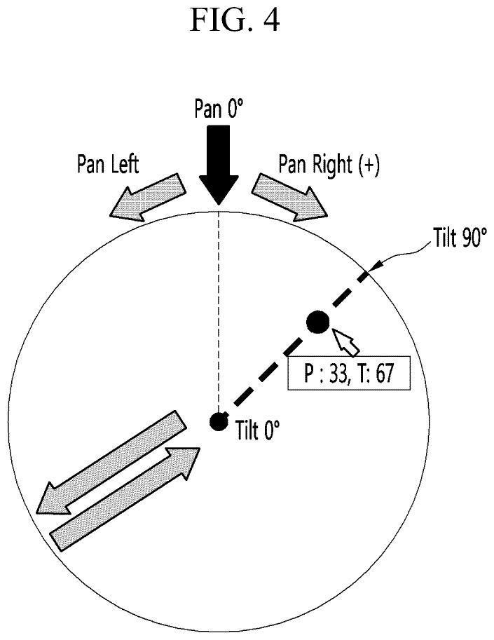

FIG. 4 illustrates a user interface of a multi-axis rotatable camera based on a hemispherical coordinate system according to an embodiment of the disclosure. As described above, the multi-axis rotatable camera may include a PTZ camera that is widely used today, and, for convenience of description, the PTZ camera will be described herein as a reference, but the disclosure is not limited thereto. As illustrated in FIGS. 1 and 2, a shooting direction of the PTZ camera may correspond to a semispherical coordinate system, and a specific shooting direction may be expressed, for example, as a pair of coordinate values corresponding to a pan angle (or pan value) and a tilt angle (or tilt value). Referring back to the user interface of FIG. 4, an outer circle may be displayed with reference to a center point. The outer circle may correspond to a pan angle of the shooting direction of the camera, and, for example, in FIG. 4, the pan angle may be expressed as 0° (zero degrees) with a top of the circle as a reference point. When the pan angle increases from 0° and reaches 360° (=0°) while rotating clockwise along the outer circle, the pan angle returns to the reference point. Meanwhile, the center point corresponds to the tilt angle of the camera of 0°. The tilt angle of the camera increases in a direction from the center point, that is, along a dashed line, and reaches 90° at a point at which the dashed line is tangent to the outer circle. For example, a point serving as a reference for the pan angle and the tilt angle, and a direction in which the pan angle and the tilt angle increase or decrease are examples, and may be set in reverse or an increase or decrease range or limit may be changed as needed. For example, when the PTZ camera is designed to be operable with a tilt angle variation range exceeding 90°, a point tangent to the outer circle due to an increase in the tilt angle along the dashed line may have a limit within the tilt angle of the PTZ camera of 110°, 130°, or a maximum of 180°, according to designs. In the case of a PTZ camera that operates with the tilt angle exceeding 90° in this way, the tilt angle changing through the UI according to the disclosure increases or decreases in proportion to the angle extending along the dashed line within an increased tilt angle limit range. Referring back to FIG. 4, an example point within the outer circle is indicated on the dashed line illustrated for convenience of description. The points correspond to, for example, a shooting direction of the camera having a pan angle of 33° and a tilt angle of 67°. The UI according to the embodiment may display (P:33, T:67) that is a pair of coordinate values of the point when the point is pointed at, for example, when the mouse is over the point. In another example, when there is an operation related to pointing regardless of the mouse being over, a coordinate value of a specific point may be displayed on a display on which the UI operates. Further, when such a pointing operation or an additional input according to the pointing operation is performed, the pan angle and the tilt angle of the camera may be controlled through the UI according to the disclosure so that a corresponding direction is shot. In a process of performing such control operations, a device providing a user interface, such as a web server (hereinafter simply referred to as a “WEB”), may transmit coordinates of a point according to the user's pointing input to a system for operating and controlling the camera according to the disclosure (hereinafter simply referred to as a “system”), and when the movement of the camera shooting direction is completed, the system may transmit current coordinates to the WEB. For example, the system includes, for example, hardware including a microcontroller, a programmable gate array (PGA), or an integrated circuit, executable software, or software components. Transmission of coordinate values between the system and the WEB may be performed continuously or periodically, but in order to reduce the burden of data transmission, the transmission may be triggered only when the user first accesses the WEB or when pointing for movement and a change in the camera shooting direction are performed.

In an embodiment according to the disclosure, a point in the UI of the multi-axis rotation camera may be set as a home. For example, in FIG. 4, a point (P:0, T:90), which is a coordinate of a point at which a downward arrow and an outline meet, may be set as the home, or a point (P:33, T:67), which is a point indicated within the outer circle, may be set as the home. For example, an arrow shown in a direction from the outside of the outline to the center point together with “Pan 0°” (e.g., the downward arrow in FIG. 4) is a figure intuitively indicating a position of the home. The figure indicating the home is not limited to an arrow, and various other shapes, symbols, letters, and the like may be utilized. In case that a home value is input by a command, pointing, or input using the UI of the disclosure when the shooting direction of the camera is directed to a different direction, the shooting direction of the camera may be controlled to return to a point corresponding to the home value.

Meanwhile, additional UI operations may be utilized in relation to control of the shooting direction of the camera. For example, when the outer circle is pointed at, only the pan angle of the camera may be controlled to vary with the tilt angle of the camera fixed along the outer circle. For example, when a straight line extending from the center point illustrated in FIG. 4 is displayed on the UI according to the disclosure and the straight line is pointed at, only the tilt angle of the camera may be controlled to vary with the pan angle of the camera fixed. An additional operation of changing an angle of the shooting direction of the camera after the outer circle or the straight line is pointed at may be achieved, for example, by clicking a pan (Left/Right) button and a tilt (Up/Down) button illustrated in FIG. 4. In another example, the operation may be achieved by additionally pointing at a point on the outer circle or the straight line instead of the pan (Left/Right) button and the tilt (Up/Down) button. As described above, when the outer circle is pointed at or the straight line extending from the center point is pointed at and when an additional input operation is performed thereafter, the WEB may transmit pan or tilt coordinates of a location pointed at by the user to the system, and when the change in the pan or tilt angle of the camera is completed, the system may transmit the moved pan or tilt coordinates to the WEB. When data is transmitted only when the pointing and shooting direction change is completed in this way, the burden of data transmission and reception may be reduced.

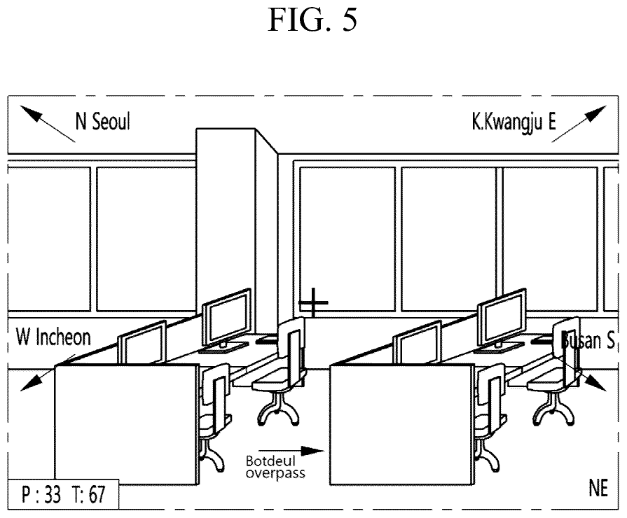

FIG. 5 illustrates an example of a (moving) image captured by the camera in a direction corresponding to a point indicated by a dot within the outer circle of FIG. 4. For example, a direction in which the surveillance camera is directed may be a direction of a central cross, and a corresponding angle may be indicated as (P:33, T:67) at a lower left end of FIG. 5.

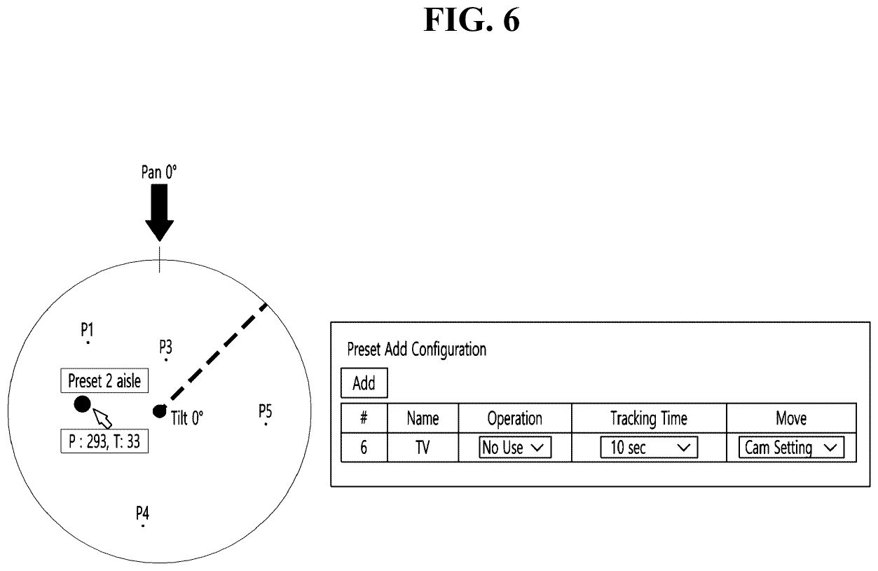

FIGS. 6 to 8 illustrate embodiments according to the disclosure related to preset points.

Referring to FIG. 6, a total of five preset shooting directions (or preset points) P1 to P5 are displayed on the UI according to the disclosure. The preset points P1 to P5 may be designated, for example, by directly inputting a (pan or tilt) value pair as a numerical value, or through additional input on the UI according to the disclosure. For example, when preset points are input on the UI according to the disclosure instead of using a separate screen or interface to set the preset points P1 to P5, an additional interface component for preset setting may be displayed, such as a pop-up menu through an operation such as a right-click of the mouse. In FIG. 6, a pointer of a current screen is pointing at a point, and a user wants to add a preset direction after the preset points P1 to P5 to the point. Then, the user can execute an operation of calling an additional menu displayed on the right side of FIG. 6 without leaving the current interface screen to set the preset points while controlling, for example, the camera through the interface screen of FIG. 4. For example, since the five preset points P1 to P5 are preset, a sixth point is automatically numbered in FIG. 6, and an interface for setting a name (TV of FIG. 6), related operation, shooting time, and a movement method of additional preset point P6 is shown on the right side. Thus, the preset points P1 to P6 may be utilized to control the camera so that the shooting direction of the camera is immediately directed in a designated direction among the preset points P1 to P6 through a separate operation or input.

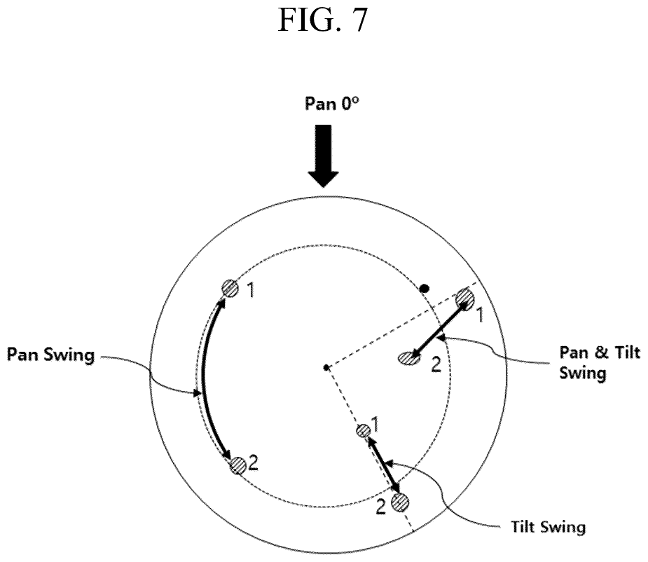

FIG. 7 illustrates an embodiment of a UI that controls the shooting direction of the camera so that the shooting direction of the camera reciprocates between two preset points according to the disclosure. For example, an additional interface for setting reciprocating control, such as a pop-up menu, may be configured to be displayed by a user operation, similar to FIG. 6. In FIG. 7, an interface for controlling the shooting direction (or shooting point) of the camera so that the shooting direction reciprocates between two points such as points marked as 1 and 2, as indicated as “1↔2” and the camera performs shooting is presented. For example, a left arrow may indicate a pan swing in which only the pan angle reciprocates between point 1 and point 2 with the tilt angle fixed, and a path indicated on the lower right may indicate a tilt swing in which only the tilt angle reciprocates between point 1 and point 2 with the pan angle fixed. For example, a movement between point 1 and point 2 on the upper right side may indicate a pan and tilt swing in which the pan angle and the tilt angle simultaneously change so that the movement is performed along the path on the UI.

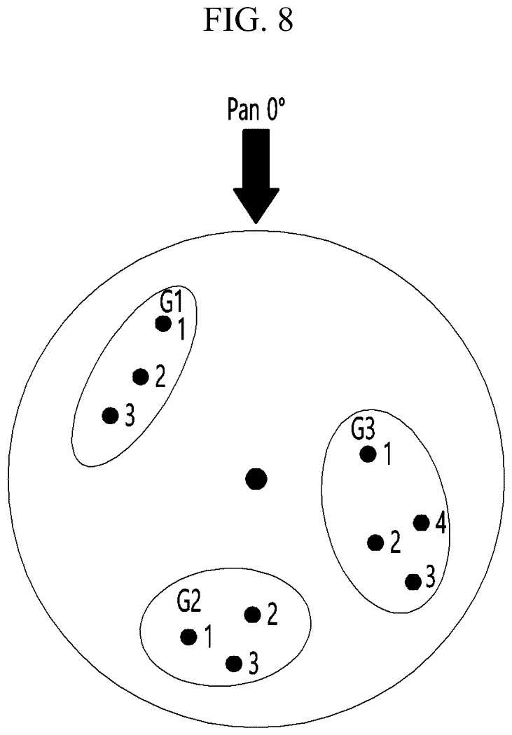

FIG. 8 illustrates an embodiment in which a plurality of points among the preset points are grouped into individual groups. For example, three groups G1, G2, and G3 are illustrated as an example. The groups G1 and G2 may each include three points as group elements, and the group G3 may include four points as group elements. The groups G1, G2, and G3 may be designated through text-based input, or may be designated by inputting two or more preset points, as in a drag operation of a mouse, in a form including a circle, an ellipse, or a polygon on a graphic display using the UI according to the disclosure or by individually pointing at the preset points. For example, an additional interface for designating a group, such as a pop-up menu, may be configured to be displayed by a user operation, similar to FIGS. 6 and 7. Points designated in the group, such as the three points in the group G1 of FIG. 8, may be controlled to implement a patrol operation in which a corresponding shooting direction of the camera moves sequentially or in an order.

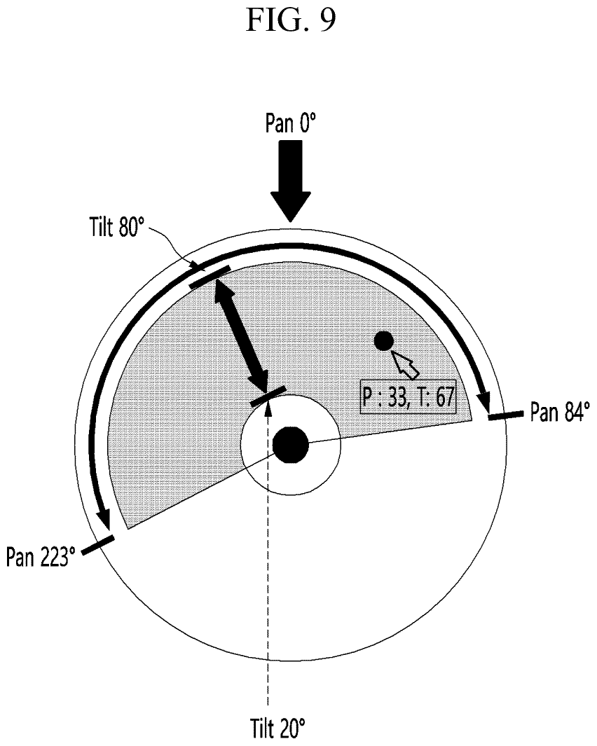

FIG. 9 illustrates an embodiment in which a range in which a pan angle and/or a tilt angle change is limited in the user interface according to the disclosure. Referring to FIG. 9, an arrow may be displayed as an example pointer at a dot position that is a current pointing position, and hemispherical coordinates of the arrow are shown. For example, the user may want to limit the rotation of the PTZ camera to a certain range for privacy or security reasons. For example, a scenario in which a panning operation is limited to an upper longer path of a panning operation path of the camera indicated by an outer circle in a range of 84 degrees and 223 degrees as illustrated in FIG. 9 is considered. For example, the user may select a pan range limit setting, for example, through a clicking operation of a mouse or another input at a point at which a pan angle is 84 degrees (or conversely, at a point at which the pan angle is 223 degrees), drag along an upper path of the outline, stop at a point at which the pan angle is 223 degrees (or at a point at which the pan angle is 84 degrees), and then end the drag input, thereby limiting a range in which the panning operation of the camera changes to a range indicated by a semicircular arrow in FIG. 9. When the user interface according to the disclosure is utilized, a tilt range limit may be conveniently set in a manner similar to the pan range limit. For example, the user may select a tilt range limit setting through a mouse clicking operation or an input operation at a point at which the tilt angle is 20 degrees (or 80 degrees), stops at a point at which the tilt angle is 80 degrees (or 20 degrees) using a mouse drag or an equivalent operation in a direction from the center point to the outline, and then end the drag input, thereby limiting a range in which a tilt operation of the camera changes to a range indicated by double arrows in FIG. 9. For example, the adoption of the range limit of the pan and/or tilt operation described with reference to FIG. 9 is not intended to exclude a direct input manner through another interface.

The term “one” as used in the disclosure is defined as one or one or more. Further, the use of introductory phrases such as “at least one” and “one or more” in the claims should not be construed to mean that introduction of another claim element due to an ambiguous phrase “one” limits any specific claim including the introduced claim element for an invention including only such an element, even when the same claim includes introductory phrases such as “at least one” and “one or more” and the ambiguous phrase “one.”

Embodiments of the technology of the disclosure have been described above with reference to the accompanying drawings. The terms or words used in the disclosure and claims should not be construed as being limited to usual or dictionary meanings, but should be construed as having meanings and concepts consistent with the technical spirit of the disclosure. The scope of the disclosure is not limited to the embodiments disclosed in the disclosure, and the disclosure may be modified, changed, or improved in various forms within the scope described in the spirit of the disclosure and claims.

What is claimed is:

1. A method of providing a user interface (UI) for controlling a shooting direction of a camera, the method comprising:
providing an outer circle corresponding to a pan angle of the shooting direction of the camera, the outer circle comprising a first point being set as a reference point having a value of 0°; and
providing a coordinate value on a hemispherical coordinate system for a second point on the outer circle,
wherein the coordinate value of the second point is expressed as a pair of coordinate values (a, b), where ‘a’ denotes a pan angle corresponding to a point at which a straight line extending through the point from a center point of the outer circle is tangent to the outer circle and ‘b’ denotes a tilt angle of the camera proportional to a distance from the center point to the outer circle on the straight line based on a value of the center point on the straight line being 0° and the point tangent to the outer circle being set to correspond to a maximum tilt angle of the camera.

2. The method of claim 1, wherein the UI controls the pan angle and the tilt angle of the camera to correspond to the pair of coordinate values (a, b) of the second point pointed at on the hemispherical coordinate system.

3. The method of claim 2, wherein the shooting direction of the camera is returned to a direction corresponding to a predefined default coordinate value based on a home value being input.

4. The method of claim 2, wherein the pair of coordinate values (a, b) corresponding to the second point is displayed on the UI.

5. The method of claim 1, wherein one or more points are preset on the UI so that the shooting direction of the camera is controlled.

6. The method of claim 5, wherein two or more points are preset on the UI, and
wherein the shooting direction of the camera is controlled to sequentially correspond to the preset two or more points.

7. The method of claim 6, wherein the preset two or more points are designated by an operation of designating a shape including the two or more points on the UI or by an operation of pointing to each of the two or more points.

8. The method of claim 5, wherein two points are preset on the UI, and
wherein the shooting direction of the camera is controlled to reciprocate between the preset two points.

9. The method of claim 2, wherein the shooting direction of the camera is controlled such that a dynamic range of the pan angle of the camera is limited between two points on the outer circle by designating the two points on the UI.

10. The method of claim 2, wherein the shooting direction of the camera is controlled such that a dynamic range of the tilt angle of the camera is limited between two points on the straight line by designating the two points on the UI.

11. A method of providing a user interface (UI) for controlling a shooting direction of a camera: the method comprising:
providing an outer circle corresponding to a pan angle of the shooting direction of the camera, the outer circle comprising a first point being set as a reference point corresponding to a pan angle of 0°; and
providing a coordinate value on a hemispherical coordinate system of a second point on the outer circle,
wherein the coordinate value of the second point is expressed as a pair of coordinate values (a, b), where ‘a’ denotes a pan angle corresponding to a point at which a straight line extending through the point from a center point of the outer circle is tangent to the outer circle and ‘b’ denotes a tilt angle of the camera proportional to a distance from the center point to the outer circle on the straight line based on a value of the center point on the straight line corresponding to a tilt angle of 0° and the point tangent to the outer circle being set to correspond to a maximum tilt angle of the camera, and
wherein the shooting direction of the camera is controlled by adjusting one of the tilt angle and the pan angle of the camera and by fixing the other of the pan angle and the tilt angle, based on the straight line.

12. The method of claim 11, wherein the pair of coordinate values (a, b) corresponding to the second point is displayed on the UI.

13. The method of claim 11, wherein one or more points are preset on the UI so that the shooting direction of the camera is controlled.

14. The method of claim 11, wherein two or more points are preset on the UI, and wherein the shooting direction of the camera is controlled to sequentially correspond to the preset two or more points.

15. The method of claim 11, wherein two points are preset on the UI, and
wherein the shooting direction of the camera is controlled to reciprocate between the preset two points.

16. The method of claim 11, wherein the shooting direction of the camera is controlled so that a dynamic range of the pan angle of the camera is limited between two points on the outer circle by designating the two points based on the tilt angle of the camera being fixed on the UI.

17. The method of claim 11, wherein the shooting direction of the camera is controlled so that a dynamic range of the tilt angle of the camera is limited between two points on the straight line by designating the two points based on the pan angle of the camera being fixed on the UI.
